(19) United States
(12) Patent Application Publication
(10) Pub. No.: US 2021/0365891 A1
(43) Pub. Date: Nov. 25, 2021

(54) CAREER NAVIDEER LIFESTYLE SURVEY MODULE FOR EXPLORATION OF LIFE CHOICES

(71) Applicants: Paris Gamble, Edmond, OK (US); Anthony Lyndon DePass, Freehold, NJ (US)

(72) Inventors: Paris Gamble, Edmond, OK (US); Anthony Lyndon DePass, Freehold, NJ (US)

(73) Assignee: Lifestyle Learning LLC, Edmond, OK (US)

(21) Appl. No.: 16/879,136

(22) Filed: May 20, 2020

(51) Int. Cl. G06Q 10/10

(52) U.S. Cl. CPC G06Q 10/1053

(57) ABSTRACT

A system of the Career Navideer Lifestyle Survey module for exploration of life choices is provided. The system comprises a computer and the Career Navideer Lifestyle Survey module stored in the computer that when executed processes received responses to questions asked of a respondent in a lifestyle survey, the responses describing lifestyle choices of the respondent. The system calculates, based on the received responses and data, and using at least one algorithm, a lifestyle index.

### CROSS REFERENCE TO RELATED APPLICATIONS

The present disclosure is related to U.S. Provisional Patent Applicant No. 62/926,910 filed Oct. 28, 2019, the contents of which are included herein in their entirety.

### FIELD OF THE INVENTION

The present disclosure is in the field of lifestyle guidance and career and personal management. More particularly, the present disclosure provides systems and methods of a lifestyle survey module to discover lifestyle objectives of a student or adult user and may assist in mapping the user's career and other choices for a path that may enable the user to achieve desired objectives attainable via these choices.

### BACKGROUND

Students planning their academic studies and adults considering career changes face a confusing array of choices. The amount of career material that is available is voluminous and daunting. A student or adult should ask him/herself, “What does my ideal lifestyle look like, both personally and professionally?” Most people know that they want more out of life, but often are not sure what “more” really means. After the person comes to the realization that there is a gap between where they are and where they want to be, the next step is getting clear on where they want to be. They should think about the experiences and things that they want to have and about the impact they wish to make with their life. Most people cannot make wise choices that properly weigh the available information without guidance.

### BRIEF DESCRIPTION OF THE FIGURES

FIG. 1 is a block diagram of a system of a lifestyle survey module for exploration of life choices according to an embodiment of the present disclosure.

FIG. 2 is a capture of a screen view of a system of lifestyle survey module for exploration of life choices according to an embodiment of the present disclosure.

FIG. 3 is a capture of a screen view of a system of lifestyle survey module for exploration of life choices according to an embodiment of the present disclosure.

FIG. 4 is a capture of a screen view of a system of lifestyle survey module for exploration of life choices according to an embodiment of the present disclosure.

FIG. 5 is a capture of a screen view of a system of lifestyle survey module for exploration of life choices according to an embodiment of the present disclosure.

FIG. 6 is a capture of a screen view of a system of lifestyle survey module for exploration of life choices according to an embodiment of the present disclosure.

FIG. 7 is a capture of a screen view of a system of lifestyle survey module for exploration of life choices according to an embodiment of the present disclosure.

FIG. 8 is a capture of a screen view of a system of lifestyle survey module for exploration of life choices according to an embodiment of the present disclosure.

### DETAILED DESCRIPTION

The Career Navideer Lifestyle Survey module presents survey questions to student and adult users about lifestyle preferences. The users are asked about where and how they may wish to live both near-term and in the more distant future. The Career Navideer Lifestyle Survey module determines costs for these lifestyle preferences and generates a lifestyle index based on total costs of the desired lifestyle.

The Career Navideer Lifestyle Survey module presents survey questions to a respondent concerning his/her desired living arrangements, location of residence, choice of transportation, and children and luxuries of interest such as vacations and restaurant visits on a regular basis. The module also receives the respondent's age and education level. The respondent may also provide his/her career interests.

Based on age and education level, the Career Navideer Lifestyle Survey module will adjust color scheme and motif to better reflect a more personal experience.

As noted, the Career Navideer Lifestyle Survey module may be used by adults in various situations. Adults may be considering career changes. After many years with an employer, they may have been terminated by their employers in a corporate downsizing and need guidance. Persons may be leaving the military or be released from incarceration and be interested in assessing their “new life”.

The Career Navideer Lifestyle Survey module may be used in retirement planning and financial budgeting. The Career Navideer Lifestyle Survey module may also be used in predictive analysis, workforce development and career changing as well as in providing relocation services and cost of living adjustment determination.

The Career Navideer Lifestyle Survey module is a web-based system comprising servers and other computing hardware as well as software applications including at least one algorithm. The algorithm(s) calculate the lifestyle.

The lifestyle survey module presents questions to user that focus on at least the following areas: where and how the user wants to live, how the user wants to eat, and what kind of transportation the user desires. The user is also asked what type of family life he/she wants and what additional things the user might want. Once the user enters his/her choices, the application calculates how much income the user might need. This is expressed as the Lifestyle Index.

The Career Navideer Lifestyle Survey module presents its questions in a graphical manner that is easy for a user to understand and may be fun for the user to work with. Photographs and user-friendly graphics are provided to assist the use in making choices.

After the Lifestyle Index calculates dollar amounts of a chosen lifestyle, the user is presented with a summary page of the selections made during the survey. From this summary page, the user may go back and change one or more survey answers to recalculate the Lifestyle Index.

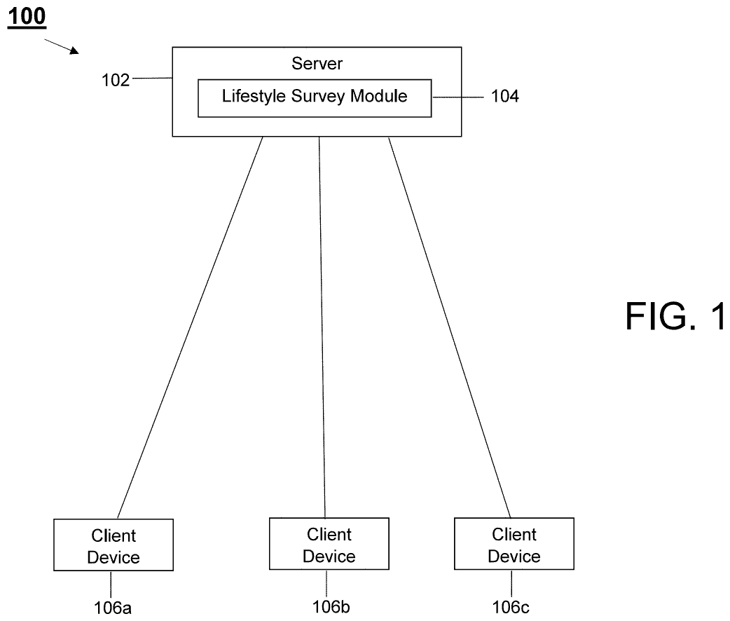

Turning to the figures, FIG. 1 is a diagram of a system of Career Navideer Lifestyle Survey module for exploration and exposure of life choices according to an embodiment of the present disclosure. FIG. 1 depicts components and interactions of a system 100 of a lifestyle survey module comprising a server 102 and a lifestyle survey module 104 or for brevity, module 104. The module 104 provides much of the inventive functionality described herein.

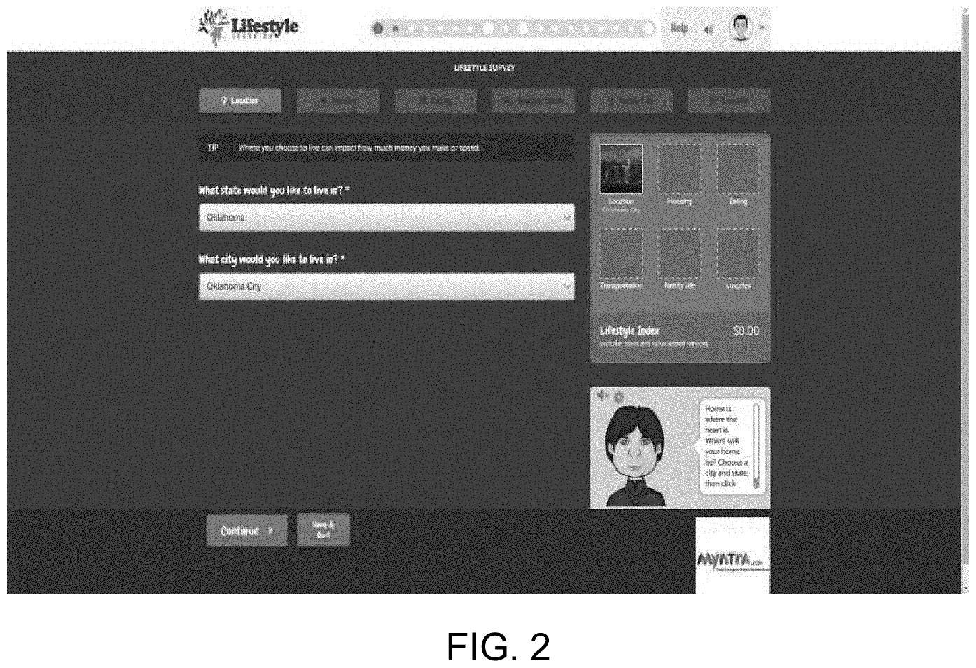

The system 100 further comprises client devices 106a-c used by students or adults interested in choosing their lifestyle goals. As the module 104 is web-based, the client devices 106a-c would use locally executing web browsers to access links leading to the module 104. FIG. 2 through FIG. 8 illustrate screens for the lifestyle survey module 104.

The lifestyle survey provided by the lifestyle survey module 104 consists of six tabs comprising Location, Housing, Eating, Transportation, Family Life and Luxuries that are shown in FIG. 2 through FIG. 7. Each tab has a specific set of questions. A user selects a button or option from a dropdown box to answer a question. On the Location tab shown in FIG. 2, the user is asked to choose a state and city where he/she would like to live.

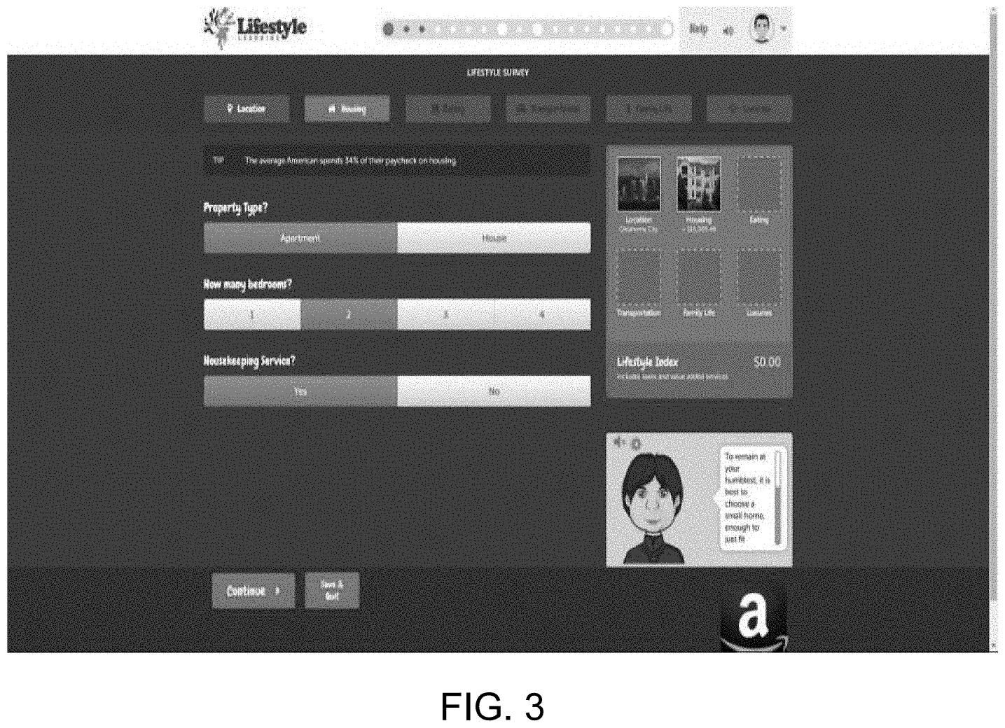

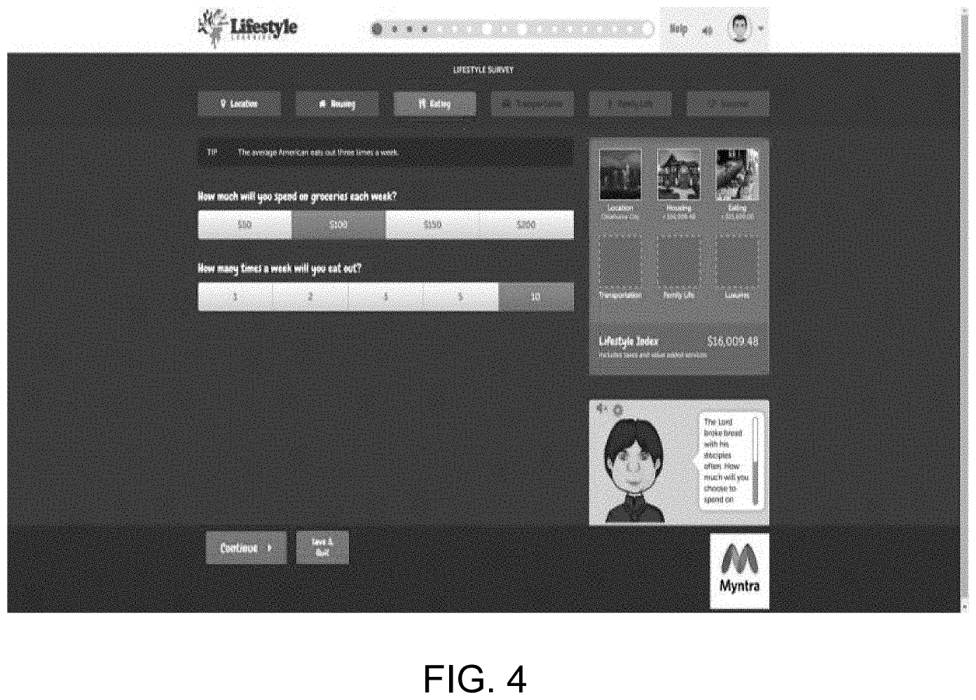

On the Housing tab shown in FIG. 3, the user is asked to choose property type, number of bedrooms and housekeeping service. On the Eating tab shown in FIG. 4, the user is asked to choose how much will be spent each on groceries and the number of times each week they will eat out.

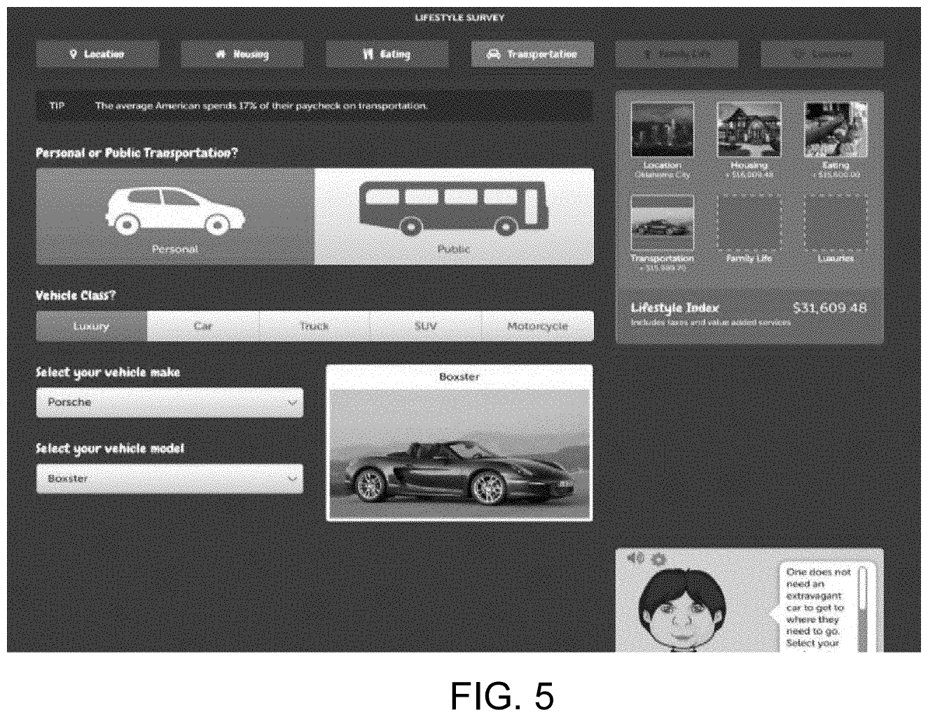

On the Transportation tab shown in FIG. 5, the user is asked to choose personal or public transportation. If the user chooses personal transportation then they are asked to select the class, make and model of that vehicle.

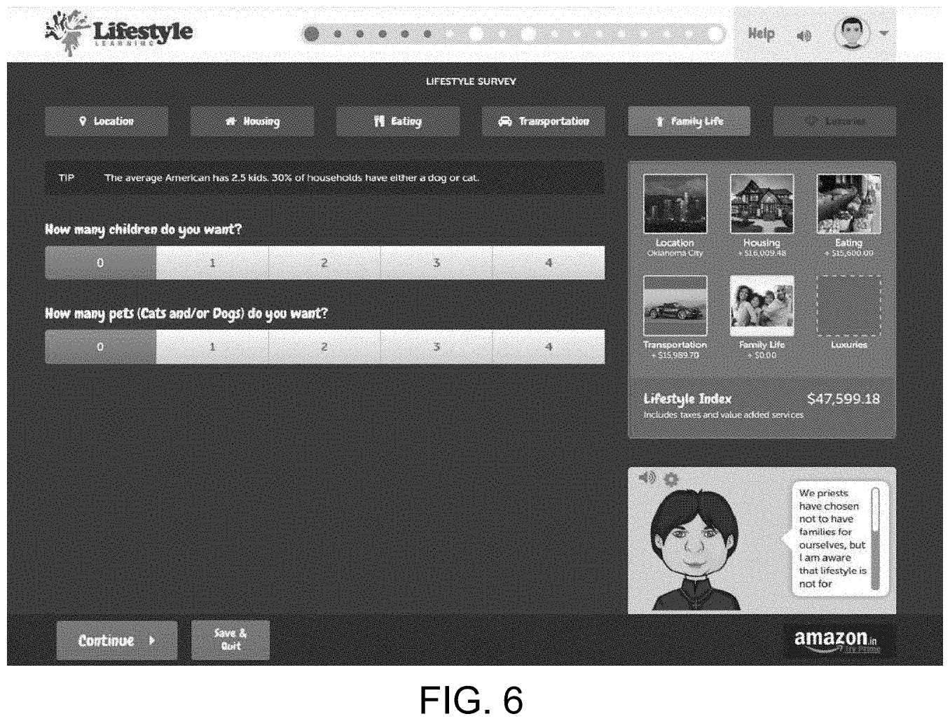

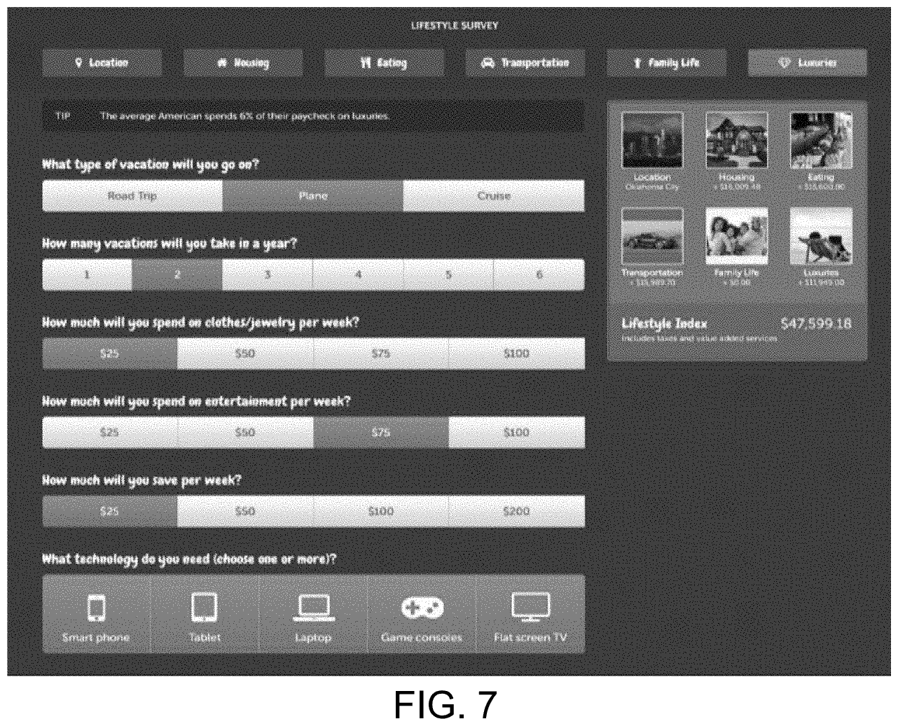

On the Family Life tab shown in FIG. 6, the user is asked to choose the number of children and/or pets they want. On the Luxuries tab shown in FIG. 7, the user is asked to choose the type of vacation they would take, number of vacations, weekly spending amount on clothes/jewelry, weekly spending amount on entertainment, amount saved each week and type of technology needed.

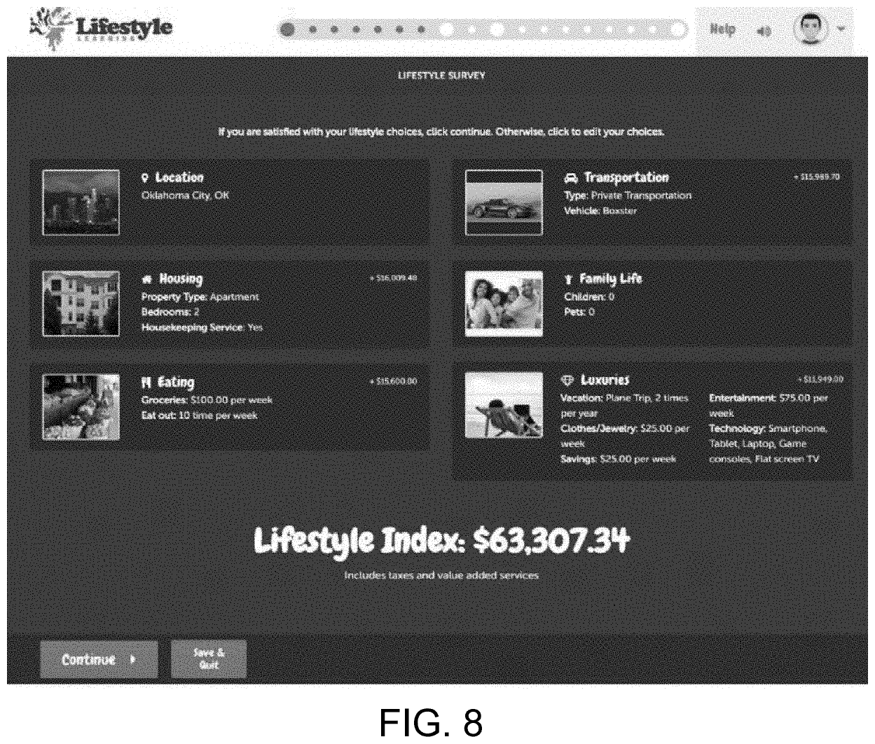

When the user selects Continue at the bottom of each tab, the module 104 activates at least one algorithm to calculate the lifestyle index and updates an information palette. Each tab of questions has a corresponding space on the palette that is updated with an image, label and calculated amount. The lifestyle index displayed on the palette is updated every time the Continue button is selected. When the Continue button is selected on the last tab in the sequence for Luxuries shown in FIG. 7, the user is taken to a lifestyle survey summary page shown in FIG. 8

The summary page summarizes the selections made on each tab and includes calculated costs for each. It provides a final monetary total for the lifestyle index. The user may make changes to selections on any tab by clicking on the tab text labels displayed on this page. The lifestyle index is a proprietary algorithm that uses selections from the lifestyle survey module 104 and additional information to calculate an approximation of the amount of money needed to live the lifestyle selected.

The lifestyle survey module 104 may be used in conjunction with a career navideer application that further aids persons in lifestyle and career decisions. The lifestyle survey module 104 may be combined with at least four other modules provided by the application. First, a profile module contains an avatar, guru, theme music and dashboard. Second, a career exploration module identifies and displays occupations that generate income within a range of a lifestyle learning index. The career exploration module provides additional career-related content (some of the content proprietary) on each occupation. Third, a game module promotes the user to build a class schedule loosely based on their last explored occupation from grades 6-12. And fourth, a ‘my metrics’ module provides a collection of reports based on choices made in the careers explored. Some reports display proprietary data.

What is claimed is:

1. A system of the Career Navideer Lifestyle Survey module for exploration of life choices, comprising:
a computer; and
a lifestyle survey module stored in the computer that when executed:
processes received responses to questions asked of a respondent in a lifestyle survey, the responses describing lifestyle choices of the respondent,
receives age data, demographic data and education-level data describing the respondent,
calculates, based on the received responses and data, and using at least one algorithm and a lifestyle index.

2. The system of claim 1, wherein the questions asked by the lifestyle survey module regarding the lifestyle choices concern the respondent's desired future lifestyle.

3. The system of claim 2, wherein the questions about the desired future lifestyle are directed to the respondent's desired living arrangements, location of residence, choice of transportation, and children and other luxuries of interest.

4. The system of claim 1, wherein the lifestyle index describes financial requirements needed to support the lifestyle choices.

5. The system of claim 1, wherein the respondent is one of a student and an adult facing career decisions.

6. The system of claim 1, wherein the Career Navideer Lifestyle Survey is presented in a series of graphical user interface screens displayed in tabular format.

7. The system of claim 6, wherein a summary page provided by the lifestyle survey module summarizes selections made on each tab, includes calculated costs for each, and provides a final monetary total for the lifestyle index.

8. A method provided by a lifestyle survey module, comprising:
a lifestyle survey module receiving inputs to at least one Career Navideer Lifestyle Survey comprising future lifestyle preferences of a respondent;
the lifestyle survey module further receiving inputs describing the respondent's age and education level; and
the lifestyle survey module using at least one algorithm to compute a lifestyle survey index based on the inputs, the index describing financial requirements to support the future lifestyle preferences.

9. The method of claim 8, wherein the respondent is a student at one of a middle school level, a high school level, and a post-secondary level.

10. The method of claim 8, wherein the lifestyle survey module selectively shares results of the survey including computations of the index with at least one of a parent and a guidance counselor of the student.

11. The method of claim 8, wherein the survey is presented as a series of graphical user interface screens displayed in tabular format.

12. The method of claim 8, further comprising the lifestyle survey module eliciting the survey responses about the respondent's desired living arrangements, location of residence, choice of transportation, and children and other luxuries of interest.

13. The method of claim 8, further comprising the lifestyle survey module presenting the at least one survey in a web-based format.

14. A lifestyle survey module-based method for assisting lifestyle decisions, comprising:
a lifestyle survey module presenting inquiries in a Career Navideer Lifestyle Survey in a tabular format accessible by a respondent,
the lifestyle survey module analyzing each tab completed by the respondent, each tab providing a subtotal cost of lifestyle choices covered by the tab; and
based on an analysis of tabs completed by the respondent, the lifestyle survey module computing a lifestyle index.

15. The method of claim 14, further comprising the lifestyle survey module presenting inquiries about the respondent's desired living arrangements, location of residence, choice of transportation, and children and other luxuries of interest.

16. The method of claim 14, wherein the Career Navideer Lifestyle Survey module applies at least one algorithm to survey results and received data to determine the lifestyle index.

17. The method of claim 16, wherein the lifestyle index describes income requirements needed to support the desired lifestyle.

18. The method of claim 14, wherein the respondent is one of a student and an adult facing career decisions.

19. The method of claim 14, wherein the lifestyle survey module further considers the respondent's age in computing the index.

20. The method of claim 14, wherein the respondent is a student the lifestyle survey module selectively shares results of the survey including computations of the index with at least one of a parent and a guidance counselor of the student.
